(19) United States
(12) Patent Application Publication
(10) Pub. No.: US 2006/0206298 A1
(43) Pub. Date: Sep. 14, 2006

(54) Method for optimization of the resources of a medical facility and associated optimization system

(76) Inventors: Andreas Kuchler, Erlangen (DE); Eva-Maria Reiter, Rottingen (DE); Karola Wollstein, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/342,478

(22) Filed: Jan. 30, 2006

(30) Foreign Application Priority Data
Jan. 28, 2005 (DE) 10 2005 004 144.2

(51) Int. Cl. G06F 9/45

(52) U.S. Cl. 703/22

(57) ABSTRACT

A method and associated optimization system make simple and fast determination of possibilities to optimize a number of medical facility resources comprising machine and personnel components regarding their efficiency. Here, a simulation model is provided numerically representing facility components, within which simulation model a number of component-specific distinguishing parameters are associated with each component and that moreover comprises a number of superordinate distinguishing parameters. An initialization parameter set is created via association of an initial value with each distinguishing parameter. An objective function of the distinguishing parameters is determined and at least one distinguishing parameter selected from the superordinate distinguishing parameters is defined as variable. The/every variable distinguishing parameter is varied according to a predetermined optimization algorithm with regard to a mathematical optimization of an objective function. An optimized resource configuration is recommended using an optimized parameter set in which the objective function corresponds to a predetermined optimization rule.

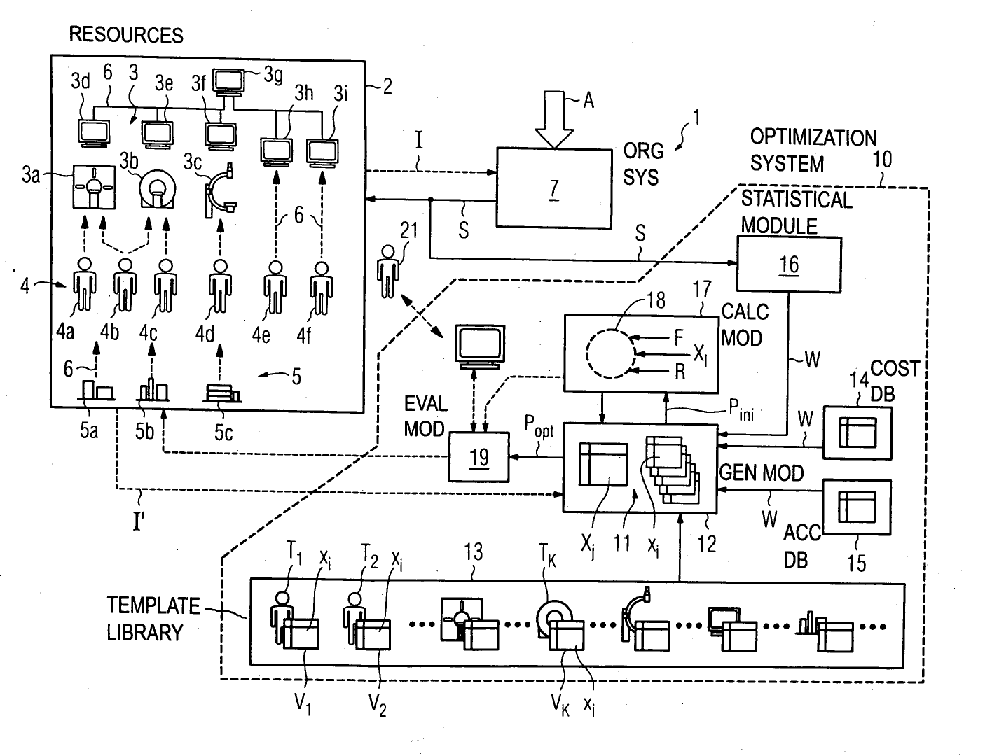

### BACKGROUND

The invention concerns a method for optimization of the resources of a medical facility, particularly of a clinic, a department of such a clinic or the like. The invention furthermore concerns an optimization system for implementation of the cited method.

The resources of a medical facility are particularly comprised of a number of machine components as well as a number of personnel components. The term “resources” furthermore comprises available consumable materials. The term “machine components” is to be understood as a specific examination apparatus, for example, a magnetic resonance (MR) tomography, a computer tomograph or a specific computer system of the facility. A “personnel component” is a specific employee, such as a doctor, a nurse or the like.

The resources of a medical facility exist in a complex network of relationships and mutual dependencies with one another. In particular, a number of employees are normally associated with one examination apparatus. Furthermore, modern examination apparatuses are frequently linked in a network of associated or superordinate computer systems, for example, control computers, finding stations, RIS/HIS components etc. Due to these relationships, a component can only be effectively used when the further components on which it depends are also available. A computer tomograph, for example, is only effectively usable when sufficient operating personnel and consumable material (such as contrast agent, etc.) are available on the one hand and when, on the other hand, the data processing network in which it is linked functions.

In order to achieve an optimally effective workflow within the facility in light of this background, automated organization systems (what are known as “schedulers”) are used to an increasing degree that assign the present resources to assignments or tasks, optimized (corresponding to the underlying relationship network) for execution of a predetermined contingency. Such a scheduler, however, always assumes the present resources and can therefore not draw a conclusion as to whether the existing resource configuration is inherently appropriate or whether an improvement with regard to the efficiency of the facility could be achienved via a change of the resources, be it via design, replacement, improvement or disassembly of components or via an alteration of the relationship network between the existing components.

In light of the complex relationship network of the resource of a medical facility, such a conclusion can also only be estimated with difficulty via rough observation of the operation of the facility.

A method for determination of the profitability/cost-effectiveness of a medical apparatus is known from German patent document DE 101 36 238 A1.

### SUMMARY

The invention is based on the object to provide a method by which possibilities to improve the resources of a medical facility with regard to their efficiency can be determined in a fast and uncomplicated, and particularly an automated manner. The invention is furthermore based on the object to provide an optimization system particularly suitable for implementation of the cited method.

With regard to the method, the object is inventively achieved via a method for optimizing resources of a medical facility, wherein the resources comprise a number of machine components and personnel components, comprising: forming a simulation model numerically representing the components of the facility; associating, in the simulation model, a number of component-specific distinguishing parameters with each component, wherein the component-specific distinguishing parameters relate to at least costs, uses, utilization and performance of the associated components, wherein said simulation model comprises a number of superordinate distinguishing parameters that characterize at least a type and number of the components considered in the simulation model as well as relationships existing between various components; creating an initialization parameter set via association of an initial value with each distinguishing parameter; determining an objective function of the distinguishing parameters; determining, as variable, at least one distinguishing parameter selected from the superordinate distinguishing parameters; varying the at least one variable distinguishing parameter according to a predetermined optimization algorithm with regard to a mathematical optimization of objective function; and providing a recommendation for an optimized resource configuration that is based on using an optimized parameter set in which the objective function corresponds to a predetermined optimization rule.

The following illustrates the invention by discussion of various embodiments of the invention.

It is accordingly provided to numerically represent, on a simulation model, the resources of a medical facility that at least comprise a number of machine and personnel components (i.e., at least one machine component and at least one personnel component. Furthermore, consumable goods assets are optionally recorded in the simulation model as further components of the resources.

The simulation model comprises a number of distinguishing parameters. Differences are hereby component-specific distinguishing parameters that are associated with a specific component of the facility and superordinate distinguishing parameters. The (component-specific) distinguishing parameters associated with a component generally contain at least specifications regarding the costs, the uses, the utilization and the capacities of the respective component.

With regard to a machine component, one or more cost-related distinguishing parameters are provided via which, for example, acquisition costs and/or operating costs as well as average repair costs of the component are accounted for. In particular retention costs are considered with regard to a personnel component.

The revenues achieved via the use of the respective components are recorded as uses in one or more corresponding usage-related distinguishing parameters. For example, these distinguishing parameters hereby comprise absolute values of the revenues achieved with the component in an observation time span or, however, relative values (such as billing rates) from which the absolute usage can be determined using the utilization of the component.

In the simplest case, a simpler percentage rate is provided for specifying the utilization of a component, which percentage specifies to what extent a specific component is productively used. As an alternative to this, the utilization of a component in a differentiated form is recorded by the distinguishing parameters. In particular, the number and type of the medical examinations effected by the component is recorded as a measure for the utilization of a component, etc.

The capacity of a component is recorded within the simulation model via distinguishing parameters that describe the technical performance of a machine component (for example, set-up time, shut-down time, average patient residence times, etc.) For a personnel component, e.g., the work time, the level of education, the treatments that can be implemented by the employee and/or the apparatuses that can be operated by the employee are recorded as specifications regarding productivity. With regard to the capacity, distinguishing parameters are optionally also recorded that characterize the minimum requirements of a component. The distinguishing parameters regarding a machine component thus appropriately contain specifications regarding the number and type of the personnel components that at the least must be available in the operation of the machine component. For a specific computer tomograph, for example, the associated distinguishing parameters contain specifications regarding a minimum number of radiologists, assistants, etc., to be associated.

The type and number of the considered components as well as the relationships existing between the components are recorded within the simulation model via the superordinate distinguishing parameters. In particular, associations of a component with a further component and/or the spatial distance between two machine components etc. are recorded.

The simulation model is initially initialized in the course of the optimization method. In other words, initial values are assigned to the distinguishing parameters of the simulation model and an initial parameter set for the optimization process is thus formed. The initial values are preferably determined using the actual conditions of the underlying facility. However, as needed, initial values deviating from these can also be specified, particularly in order to be able to simulatively “act out” specific virtual resource configurations.

Furthermore, using the simulation model, an objective function of the distinguishing parameters is determined according to the requirements of which the resources should be optimized. The total costs or the total cost/total usage ratio of the components considered in the simulation model are thereby preferably used as an objective function. Alternatively, for example, the total time, the patient throughput, etc., required for implementation of a predetermined contingency of tasks or assignments can also be determined as an objective function.

A number of superordinate distinguishing parameters (i.e., at least one such distinguishing parameter) are initially determined as variable for the actual optimization process. The variable distinguishing parameter or distinguishing parameters are now varied via a predetermined optimization algorithm until an established mathematical optimization rule is fulfilled with regard to the objective function. It is optionally provided that component-specific parameters can also additionally be determined as variable. The optimization algorithm is, in particular, a mathematical extreme value search in which the variable distinguishing parameters are varied until a minimal value or maximal value of the objective function is achieved. In the case of a total cost/total usage ratio as an objective function, for example, a minimum is appropriately sought; in the case of the patient throughput, a local or global maximum is appropriately sought as an objective function.

Alternatively, for example, it can also be provided as an optimization rule that the variable distinguishing parameters are varied until the function value of the objective function has reduced or increased by a predetermined percentage relative to the initial value.

The optimization algorithm is, in particular, a numerical, and particularly an iterative mathematical regression method. Depending on the properties of the simulation model, a deterministic or stochastic method (which can be a conventional method) is alternatively also used as an optimization algorithm. In simple cases, the mathematical equation describing the simulation model can also be achieved via mathematical analytic optimization.

If an optimized parameter set is determined in which the objective function fulfills the optimization rule, a recommendation for an optimized resource configuration is derived from this. Relative to the original resources, the recommendation can particularly provide for the addition of a new component, the disposal, or the replacement of an existing component, or a revaluation of a component. The recommendation can furthermore, for example, provide for a change of the dependencies present between two existing components.

Via the method described in the preceding, possibilities to improve the efficiency of the resources of a medical facility are indicated in a simple and fast manner that is uncomplicated with regard to personnel expenditure. The method is preferably implemented completely or largely automatically, in which, however, manual intervention in the method implementation can also be made as needed. For example, the effect of any intended resource alteration can be simulated without risk beforehand in this manner.

With regard to an automated (and therewith simplified) method implementation, it is preferably provided that the initial value of at least one utilization-related distinguishing parameter of a component is determined via automatic time recording. Such a time recording is frequently already provided innately in the course of organization and information systems such as a RIS (radiology information system) and an HIS (hospital information system) used in the medical field, such that the utilization data can be directly accessed in the course of the present method.

For usage-related distinguishing parameters, associated initial values are preferably automatically determined from a stored accounting table, if applicable, under additional consideration of the utilization of the component.

Machine distinguishing parameters are particularly provided by the manufacturer of the respective apparatus in the form of data sheets.

In a particularly advantageous embodiment of the method, the simulation model is composed of pre-configured distinguishing parameter templates, patterns, samples or models like building blocks. Such a distinguishing parameter template is respectively stored for a plurality of available component types. Each distinguishing parameter template defines the relevant component-specific distinguishing parameter for the respective component type.

Analogous to the resources of the real facility that is modularly comprised of its individual components, the simulation model is comprised of instances of the distinguishing parameter templates corresponding to these components. The simulation model can be simply and modularly generated in this manner with regard to a virtually arbitrary resource configuration to be simulated and likewise simply be changed as needed.

With regard to the optimization system provided for implementation of the method described in the preceding, the object is inventively achieved via an optimization system for optimization of resources of a medical facility, wherein the resources comprise a number of machine components; and personnel components; the optimization system comprising: a model generation module that generates a simulation model numerically representing the components of the facility, within which simulation model a number of component-specific distinguishing parameters are associated with each component, which component-specific distinguishing parameters characterize at least costs, usage, utilization and performance of the associated components, the simulation model defining a number of superordinate distinguishing parameters that characterize at least a type and number of the components considered in the simulation model as well as relationships existing between various components; an input for assigning distinguishing parameters with respectively one associated initial value; a calculation model that varies a number of superordinate distinguishing parameters determined as variable according to requirements of a mathematical optimization of an objective function of the distinguishing parameters; and an evaluation model that derives a recommendation for an optimized resource configuration using an optimized parameter set in which the objective function corresponds to a predetermined optimization rule.

Thus, the optimization system comprises a model generation module that is fashioned for generation of the simulation model as well as an input by way of which corresponding initial values can be assigned to distinguishing parameters of the simulation model. The input preferably comprise a statistical model that provides (from statistical detection of the work processes running in the real facility) initial values for utilization-related distinguishing parameters, a cost databank that provides the initial values for cost-related distinguishing parameters and an accounting databank that provides accounting rates as an initial value for usage-related distinguishing parameters.

The optimization system furthermore comprises a calculation module in which the optimization algorithm described in the preceding is implemented as well as an evaluation module that is fashioned to derive the recommendation for an optimized resource configuration using the optimized parameter set and to output this recommendation for acceptance or rejection.

In a preferred embodiment, the optimization system furthermore comprise a storage module as a template library for the distinguishing parameter templates described in the preceding.

### DESCRIPTION OF THE DRAWINGS

An exemplary embodiment of the invention using a drawing is subsequently explained in detail. The single FIGURE shown therein is a block diagram that schematically simplifies a medical facility as well as an optimization system for optimization of the resources of the facility.

### DETAILED DESCRIPTION OF THE PREFERRED EMBODIMENTS

The exemplary shown medical facility 1, according to an embodiment of the invention, is, for example, a radiology department of a clinic. The facility 1 comprises a specific configuration of resources 2 represented as pictograms. The resources 2 comprise a number of machine components 3, personnel components 4 (i.e., employees) as well as (material) components 5 (i.e., consumable good assets).

The machine components 3 are examination or therapy apparatuses, computer systems, etc. In detail, the resources 2 comprises a magnetic resonance tomograph as component 3a, a computer tomograph as component 3b and a C-arm x-ray apparatus as component 3c. Further machine components 3d through 3i are electronic optimization, information or evaluation systems, in particular RIS or PACS components. Further machine components 3h and 3i are what are known as “finding stations” for medical assessment of digital examination data.

Personnel components 4 are, in particular, assistants (components 4a and 4b), radiologists (components 4e and 4f), etc. In detail, the resources 2 comprise personnel components 4a-4f. The resources 2 additionally individually comprise three material components 5a-5c.

A network of (partially mutual) relationships 6 exists between the individual components 3, 4, 5. For example, the personnel components 4a, 4b, the material component 5a and the machine component 3d are associated with the component 3a, i.e., with the MR tomograph. For example, these relationships manifest themselves in that the MR tomograph (component 3a) can only be operated when the personnel components 4a and 4b and the material component 5a are available, etc.

The facility 1 furthermore comprises an organization system 7, particularly a conventional scheduler, that is fashioned to use the resources 2 optimized for implementation of incoming tasks A or assignments. For this, the optimization system 7 receives information I about the available components 3, 4, 5 of the resources 2 and returns corresponding assignment instructions S to the components 3, 4, 5.

An optimization system is furthermore associated with the facility 1, which optimization system is particularly a component of a data processing system and which is fashioned to determine, using a simulation model 11 of the resources 2, a resource configuration optimized with regard to the efficiency of the facility 1.

For this, the optimization system 10 comprises a model generation module 12 that is fashioned to generate the simulation model 11 or—in as much as the simulation model 11 already exists—to modify the simulation model 11. The simulation model 11 itself comprises a number of component-specific distinguishing parameters xᵢ (i=1, 2, . . . ) as well as a number of superordinate distinguishing parameters Xⱼ (=1, 2, . . . ) that numerically represent the properties of the resources 2.

Each component-specific parameter xᵢ hereby stands for one property that is associated with a specific component 3, 4, 5. In general, the distinguishing parameters xᵢ associated with a specific component 3, 4, 5 comprise specifications that characterize costs, uses, utilization, and capacity of these components 3, 4, 5.

Particularly, one distinguishing parameter xᵢ is provided per component 3, 4, 5, which one distinguishing parameter xᵢ represents the monthly costs to be estimated for the corresponding component within a monitoring time span (preferably monthly). For a machine component 3, investment costs, renting or leasing costs, operating costs, and (if applicable) average repair costs are considered. The incident salary costs are considered for a personnel component. The acquisition costs are considered for a material component 5.

Usage-related distinguishing parameters xᵢ concern accounting costs that can be accounted for given use of the corresponding components 3, 4, 5. In particular, given machine components 3 and personnel components 4, accounting rates differentiated according to medical examination types are hereby incorporated as distinguishing parameters xᵢ.

The number of the examinations of a specific type that are implemented by the corresponding components 3, 4 per observation time span, differentiated for machine components 3 and personnel components 4, are recorded as utilization-related distinguishing parameters xᵢ. The consumption per observation time span, measured at the average inventory, is recorded as a utilization-related distinguishing parameter xᵢ for a material component 5.

In particular, specifications regarding start-up times, shut-down times, and patient residence times, differentiated according to medical examination types, are recorded as performance-related distinguishing parameters xᵢ for a machine component 3a through 3i. In particular, work times and treatment duration, differentiated according to treatment types, are recorded in this regard for a personnel component 4a through 4f.

Superordinate distinguishing parameters Xⱼ specify the number and type of the components 3, 4, 5 numerically considered in the simulation model 11. The superordinate distinguishing parameters Xⱼ additionally numerically represent the relationships 6 existing between the components 3, 4, 5, in that they specify associations between various components 3, 4, 5 etc.

In the course of the optimization method implemented by way of the optimization system 10, the simulation model 11 is initially generated using information I′ about the existing components 3, 4, 5 and their relationships 6 such that the simulation model 11 numerically represents real resources 2 of the facility 1. The information I′ can be partially or completely automatically supplied to the simulation model or be input manually.

The model generation module 12 generates the simulation model 11 according to the building block principle using distinguishing parameter templates Vₖ (k=1, 2, . . . ) that are provided to the model generation module 12 from a storage model (subsequently designated as a template library 13). Each distinguishing parameter template Vₖ is specifically for a specific component type Tₖ (k=1, 2, . . . ) that is in principle provided as a component of the resources 2. The component types Tₖ particularly comprise types of employees of various degrees of education, examination apparatuses (such as MR tomographs or computer tomographs) of various types, various computer systems and consumable materials. Similar components with different financing models (for example, a purchased apparatus relative to a corresponding leased apparatus, a salaried employee relative to a comparable temporary employee, etc.) are also optionally considered in different component types Tₖ. Each distinguishing parameter template Vₖ defines the component-specific parameter xᵢ relevant for the respective component type Tₖ.

The components 3a-3i, 4a-4f, 5a-c forming the actual resources of the facility 1 are instances of a respectively associated component type Tₖ, thus respectively represent a concrete exemplar of the associated component type Tₖ. For example, the component 4a is a specific assistant and thus corresponding to the component type T₁; the component 3a likewise corresponds to a component type Tₖ focused on a specific MR tomograph, etc.

For each component 3a-i, 4a-f, 5a-c, the model generation module 12 corresponding selects from the template library 13 the distinguishing parameter template Vₖ corresponding to the component type Tₖ and adds this distinguishing parameter template Vₖ to the simulation model 11. The finished simulation model 11 thus contains a corresponding instance of the respective distinguishing parameter template Vₖ for every component 3a-i, 4a-f, 5a-c.

In a next step, the simulation model 11 is initialized, i.e., it is provided that an associated initial value W is allocated to each of the distinguishing parameters xᵢ, Xⱼ. Initial values W for cost-related distinguishing parameters xᵢ are provided from a cost databank 14; initial values W for usage-related distinguishing parameters xᵢ are provided from an accounting databank 15 in which accounting rates (if applicable, differentiated according to examination type, component type Tₖ, health insurance, etc.) are stored. Initial values W regarding utilization-related distinguishing parameters xᵢ are provided to the simulation model 11 from a statistical model 16 that (using the classification instructions S of the organization system 7) statistically records the utilization of the components 3, 4, 5, i.e., particularly the number and type of the examinations implemented per component as well as optional non-productive times of individual components 3, 4, 5 and/or patient wait times.

Performance-related distinguishing parameters xᵢ that are normally invariable for a specific component type Tₖ are preferably already recorded as constants beforehand in the stored distinguishing parameter templates Vₖ and inasmuch are already allocated with the corresponding initial value W. The superordinate distinguishing parameters Xⱼ are allocated with initial values W that are determined using the information I′ about the existing resources 2.

For a mathematical optimization of the simulation model 11, the optimization system 10 furthermore comprises a calculation model 17. An optimization algorithm 18 is implemented in the calculation model 17; an objective function F=F(Xⱼ, xᵢ) of the distinguishing parameters Xⱼ and xᵢ as well as an optimization rule R are provided for the optimization algorithm 18. The objective function F is generally a mathematical rule, represented using the simulation model 11, that reproduces (dependent on the distinguishing parameters Xⱼ and xᵢ) a function value according to the requirements of which the optimization algorithm 18 measures the progress of the optimization process. In particular, the cost-usage ratio is drawn upon as an objective function F, which cost-usage ratio results from the simulation model 11 under consideration of the supplied utilization data.

The optimization rule R provides a criterion for the success of an optimization process implemented by the optimization algorithm 18. For example, the optimization rule R contains the instruction to determine a minimum of the cost-usage ratio as an objective function F with a predetermined precision. A number of setting parameters Xₗ (lεj) from the superordinate distinguishing parameters Xⱼ that should be handled as variable in the course of the optimization process are furthermore provided to the optimization algorithm 18. An arbitrary subset of the superordinate distinguishing parameters Xⱼ that comprise at least one distinguishing parameter Xₗ can be selected as variable. It is optionally provided that component-specific distinguishing parameters xᵢ can also be selected as variable.

The optimization algorithm 18 can be a numerical regression method. At the beginning of the optimization process, the distinguishing parameters xᵢ, Xⱼ assigned with the initial values W are supplied to the optimization algorithm 18 as an initial parameter set Pᵢₙᵢ. The optimization algorithm varies one or more of the variable distinguishing parameters Xₗ such that the objective function F is positively influenced with regard to the optimization rule R and returns the changed values of the distinguishing parameters Xₗ to the model generation module 12, which reconstructs the simulation model 11 under consideration of the variations.

Insofar as the optimization algorithm 18 is iteratively designed, the distinguishing parameters xᵢ, Xⱼ of the changed simulation model 11 together with the associated values are in turn supplied to the calculation module 17, which re-modifies the values of the variable distinguishing parameters Xₗ and in turn returns these to the model generation module 12. This process is repeated until the optimization rule R is fulfilled, particularly until a minimum of the cost-usage ratio as an objective function F is determined with the specified precision.

Via the release of superordinate distinguishing parameters Xₗ as variables, in the course of the optimization process, the simulation model 11 is modified relative to the initial, fundamental configuration of the resources 2. In particular, virtual new components can be added to the simulation model 11 or existing components can be removed or replaced via changing of the corresponding distinguishing parameters Xₗ. Additionally, the relationships and dependencies specified between the virtual components of the simulation model 11 can be altered relative to the relationships of the real components 3a-3i, 4a-4f, 5a-5c. In particular, the association of a personnel component with a machine component can be changed etc. The method determines, using the objective function F, to what extent a concrete change of the resource configuration for optimization of the objective function is reasonable, particularly to what extent it leads to a cost savings.

Given fulfillment of the optimization rule R, the calculation model 17 terminates the optimization process and leaves the simulation model 11 in an end state described by an optimized parameter set Pₒₚₜ of the distinguishing parameters xᵢ, Xⱼ and their values. Via a corresponding instruction C, the calculation model 17 now activates an evaluation module 19 that derives a recommendation B for an optimized resource configuration of the facility 1 using the parameter set Pₒₚₜ. The recommendation B preferably has the form of a written report in which are indicated the optimized resource configuration and in particular its difference relative to the existing resources 2 of the facility 1 as well as the influence of the proposed optimization on the objective function F. The proposal B is output to a user 21 by the evaluation module 19 on a control console 20 of the optimization system 10 comprising an input and output such as a screen, keyboard, mouse, etc. The recommendation B can also be output in an equivalent manner in paper form, as e-mail, or in a comparable manner. The user can now accept or dismiss the recommendation B, whereby, in the event of an acceptance, the change of the resources 2 of the facility 1 that is offered by the recommendation B is automatically or manually implemented.

The acceptance process set in motion by the evaluation module 19 is optionally effected in a differentiated manner (in a manner not shown in detail), in that partial recommendations that respectively contain changes for a partial range of the resources 2 are transmitted to various users responsible for the respective partial range. For example, alteration recommendations for the personnel component 4 of the resources 2—for example, an advanced training of the radiologist (component 4e), the employment of an additional assistant for the computer tomograph (component 3b), or a change of the association of the present personnel with the present examination apparatuses (components 3a through 3c)—are forwarded to a personnel department of the facility 1, while change recommendations with regard to the machine components 4 are forwarded to an administration position of the facility 1 that is responsible for this. If the recommendation B concerns both changes to personnel components 4 and changes to machine components 3, the evaluation module 19 thus only initiates the implementation of the recommendation B when all responsible positions of the facility 1 have accepted the respective partial recommendations.

The method described in the preceding is alternately implemented at the corresponding initiation by a user or automatically at regular time intervals, particularly monthly. Details of the method implementation can be amended as needed, specific to the user. In particular, distinguishing parameters xᵢ, Xⱼ of the simulation model 11 or initial values W for the optimization process that deviate from the actual conditions of the facility 1 can be provided. This is particularly reasonable in order to be able to “act out” specific scenarios virtually (and thus without risk). The objective function F, the optimization rule R and the variable distinguishing parameters Xₗ are preferably freely configurable for this purpose.

However, with regard to the selection of the objective function F, the optimization rule R and the variable distinguishing parameters Xₗ specific, advantageous defaults can alternatively also be provided in order to simplify the handling of the optimization system 10.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for optimizing resources of a medical facility, wherein the resources comprise a number of machine components and personnel components, comprising:
forming a simulation model numerically representing the components of the facility;
associating, in the simulation model, a number of component-specific distinguishing parameters with each component, wherein the component-specific distinguishing parameters relate to at least costs, uses, utilization and performance of the associated components, wherein said simulation model comprises a number of superordinate distinguishing parameters that characterize at least a type and number of the components considered in the simulation model as well as relationships existing between various components;
creating an initialization parameter set via association of an initial value with each distinguishing parameter;
determining an objective function of the distinguishing parameters;
determining, as variable, at least one distinguishing parameter selected from the superordinate distinguishing parameters;
varying the at least one variable distinguishing parameter according to a predetermined optimization algorithm with regard to a mathematical optimization of objective function; and
providing a recommendation for an optimized resource configuration that is based on using an optimized parameter set in which the objective function corresponds to a predetermined optimization rule.

2. The method according to claim 1 wherein, the initial values for the initial parameter set are acquired using existing components of the facility (1).

3. The method according to claim 2, wherein the initial value of at least one distinguishing parameter that characterizes the utilization of a component is determined via automatic time recording.

4. The method according to claim 2, wherein the initial value of at least one distinguishing parameter that characterizes the use of a component is automatically determined using stored accounting rates.

5. The method according to claim 1, wherein the objective function reflects the total costs or a total cost or total use ratio of the components considered in the simulation model.

6. The method according to claim 1, wherein the forming of the simulation model ensues utilizing the pre-configured distinguishing parameter templates as building blocks, of which each pre-configured distinguishing parameter template is stored with regard to an available component type.

7. An optimization system for optimization of resources of a medical facility, wherein
the resources comprise:
a number of machine components; and
personnel components;
the optimization system comprises:
a model generation module that generates a simulation model numerically representing the components of the facility, within which simulation model a number of component-specific distinguishing parameters are associated with each component, which component-specific distinguishing parameters characterize at least costs, usage, utilization and performance of the associated components, the simulation model defining a number of superordinate distinguishing parameters that characterize at least a type and number of the components considered in the simulation model as well as relationships existing between various components;
an input for assigning distinguishing parameters with respectively one associated initial value;
a calculation model that varies a number of superordinate distinguishing parameters determined as variable according to requirements of a mathematical optimization of an objective function of the distinguishing parameters; and
an evaluation model that derives a recommendation for an optimized resource configuration using an optimized parameter set in which the objective function corresponds to a predetermined optimization rule.

8. The optimization system according to claim 7, further comprising:
a storage model comprising one associated distinguishing parameter template per available component type for a number of available component types for generation of the simulation model as a building block system.
